(19) United States
(12) Patent Application Publication
(10) Pub. No.: US 2019/0276134 A1
(43) Pub. Date: Sep. 12, 2019

(54) AIRCRAFT CARGO DECK AND METHOD FOR MANUFACTURING A FLOOR MODULE

(71) Applicant: TELAIR INTERNATIONAL GMBH, Miesbach (DE)

(72) Inventors: Thomas HUBER, Schliersee (DE); Richard HOLZNER, Stephanskirchen (DE)

(21) Appl. No.: 16/291,162

(22) Filed: Mar. 4, 2019

(30) Foreign Application Priority Data
Mar. 7, 2018 (DE) 102018105278.2
Apr. 16, 2018 (DE) 102018108950.3

(51) Int. Cl. B64C 1/20

(52) U.S. Cl. CPC B64C 1/20; B64D 2011/0046; B64C 2211/00

(57) ABSTRACT

A cargo deck of an aircraft, including a series of at least two floor modules arranged side by side and made of a fiber-composite material. The floor modules each comprise at least one core in the form of a foam core and/or structural core which is interposed between a first cover layer made of fiber-reinforced plastic and a second cover layer made of fiber-reinforced plastic, wherein the floor modules each comprise a coreless peripheral edge region for producing an, in particular laminar, materially bonded connection between the cover layers. The floor modules are arranged in such a way that sections of the coreless edge regions of the floor modules arranged side by side overlap one another, wherein at least one sealing strip, in particular made of silicone foam, is provided between the mutually overlapping edge regions.

The invention relates to a cargo deck of an aircraft and a method for manufacturing a floor module.

Cargo brought into the hold of an aircraft through a door must be introduced into said hold and be secured in the hold. The floor of such a cargo compartment, which is part of the cargo deck, is preferably of modular design, as is known, for example, from EP 1 646 556 B1.

A major problem in the construction of such a cargo floor is the conflicting demands for great stability and low weight. In addition, neither the individual components nor their installation should be too costly, as this increases costs.

Furthermore, the cargo floor should be watertight and fireproof and prevent liquid from penetrating, for example into the bilge.

Both for the production and for the assembly of cargo floors, it is important that this should be as simple as possible.

The invention is based on the object of providing a cargo deck with floor modules of an aircraft that eliminates the problems described above. In particular, a cargo deck and a manufacturing method for a floor module that is simple and highly functional or efficient shall be described. The cargo deck shall have high stability and water resistance or water impermeability at low weight. Furthermore, gas tightness is required in many applications, so that extinguishing gas, e.g. halon, can be introduced in the event of fire into certain areas without escaping. Under no circumstances shall the extinguishing gas be allowed to reach the passenger compartment and/or the cockpit from the cargo compartment. In general, these properties should be accompanied by low manufacturing and installation costs.

The object is solved by a cargo deck according to claim 1 and a manufacturing method according to claim 9.

In particular, the object is solved by a cargo deck of an aircraft which comprises a series of at least two floor modules arranged side by side and made of a fiber-composite material, wherein the floor modules each comprise at least one core in the form of a foam core and/or structural core which is interposed between a first cover layer made of fiber-reinforced plastic and a second cover layer made of fiber-reinforced plastic. In accordance with the invention, the floor modules each comprise a coreless peripheral edge region for producing a materially bonded connection between the cover layers, wherein the floor modules are arranged in such a way that sections of the coreless edge regions of the floor modules arranged side by side overlap one another, wherein at least one seal, in particular a sealing strip, is provided between the overlapping edge regions.

A core element of the present invention, therefore, consists of producing floor modules as fiber-composite materials, wherein these modules, arranged next to each other, form an (essentially) water-impermeable, (essentially) gas-impermeable and a walkable surface. The water- and/or gas-impermeable surface can be achieved by overlapping the floor modules in sections, especially where the edge regions are provided. In addition, a sealing strip can be provided to compensate for unevenness. The sealing strip can consist of silicone tape.

In one embodiment, the sealing strip has a thickness of approx. 1 to 5 mm, in particular approx. 2.5 mm. The sealing strip can have a width of approx. 1 to 4 cm, preferably approx. 2 cm.

An appropriate width and thickness are sufficient to effectively seal the floor modules against each other and/or against elements on which they are supported.

In one embodiment, the sealing strip is pre-assembled before the floor modules are inserted into the cargo deck, especially on the floor modules. For this purpose, the sealing strip may include an adhesive layer, which enables the sealing strip to be bonded to at least one of the floor modules, particularly at the edges. The sealing strip can be glued in sections to a floor module or be attached to the entire peripheral edge.

The core can, as explained above, either be made of foam or of structural elements. Honeycomb or other polygonal shapes, which are known in the field of manufacturing processes for fiber-reinforced materials, are suitable structural elements. The core is thus made of much lighter material than the cover layers. The result is essentially a sandwich structure, wherein the cover layers are glued together at the edges, however. This results in an extremely rigid and stable floor module. The well-known honeycomb structure is referred to by way of example with regard to an example of a structural core. The core of at least one floor module may include recesses into which inserts are inserted to accommodate transport balls. Preferably the recesses have a diameter and/or a side length of at least approx. 2 cm, in particular of at least approx. 5 cm. Corresponding recesses can have a circular, elliptical or rectangular shape.

The provision of recesses makes it possible to partially provide functional elements within the respective floor module. The inserts allow these functional elements to be replaced and prevent the recesses from leading to a structural weakening of the respective floor module. The inserts can be made of a plastic and/or a metal alloy, for example aluminum. According to the invention, it is also conceivable to manufacture the inserts as a fiber-composite material or a plastic.

An integrated construction method using the floor layer and the cover layer, which were combined to form a monolithic structure, can also be implemented according to the invention. In this embodiment, the cover layers, e.g. floor (bottom) and cover (top) layers, can be joined together (e.g. by local removal of the core) to form a monolithic body approx. 3-4 mm thick with an area of approx. 5 cm in diameter. The mounting for the ball element can be created by means of an abrasive process, e.g. by milling or cutting out. This manufacturing process is efficient and cost-effective.

At least one of the transport balls can be rotatably mounted in a housing that can be inserted into one of the inserts. Preferably the housing has a latch so that a latched connection to the insert can be established. The latched connection also ensures safe and efficient operation of the transport ball.

In general, it should be noted that appropriate transport balls are known in this field in order to transport heavy loads, such as containers and/or freight pallets, on the cargo deck.

According to the invention, corresponding transport balls are integrated into the floor modules in such a way that retrofitting the cargo deck with ball mats or transport rollers is unnecessary. This can save further weight. The floor module itself can consist of several individual components, e.g. a lower module with integrated drainage troughs and an upper ball mat floor. The lower and/or upper module can be manufactured as described. A divisibility can be useful here for manufacturing, assembly and maintenance reasons, e.g. to enable cleaning of the drainage areas.

The installation of the transport balls before the floor modules are installed in the cargo deck also facilitates the installation of the cargo deck.

The overlapping sections of the edge regions may each comprise a lower edge section of a first floor module and an upper edge section of a second floor module. The lower edge section preferably has a downwardly inclined upper side and the upper edge section an upwardly inclined lower side. The inclination may be defined in such a way that it is defined in relation to a bearing surface of the floor modules on perforated rails, cross members and/or longitudinal members.

The inclination leads to the fact that pushing the modules together leads to a sealing of the modules against each other. The inclination also allows a module to be retrofitted and removed at a later date, which is arranged in a row between a large number of modules. Finally, the module can be detached, lifted and sucked out of the area below the upper edge section. The module can be inserted into a row retroactively in an appropriate manner. In one embodiment, adjacent edge sections lie on different planes, so that overlapping is possible even without the described inclination. In general, a seal in overlapping areas is preferable to a butt seal.

According to the invention, it is possible to glue individual edge regions of neighboring modules together. Preferably, a detachable connection, in particular a screw connection, is made between the edge regions. The floor modules according to the invention may have drill holes in the edge regions for this purpose.

In one embodiment, the overlapping sections of the edge region are screwed together at least partially, preferably using a clip groove or a snap nut. Bolting allows easy maintenance and assembly of the cargo deck.

The first cover layer and/or the second cover layer may comprise a plurality of fiber layers. The first and second cover layers may have a similar or identical layer structure. The first cover layer preferably differs from the second cover layer in its layer structure. The layer structure can thus be designed and optimized with regard to the loads that occur, e.g. more fibers in the upper layers, in order to minimize the risk of damage caused by the cargo.

The fiber layers used can be bidirectional or multidirectional fabrics. The fibers used may include carbon fibers and/or aramid fibers and/or glass fibers.

In one embodiment, at least one of the cover layers has a thickness less than 3 mm, in particular less than 2 mm.

The first cover layer - preferably the upper cover layer—may comprise fiber layers of glass fibers and carbon fibers. In one embodiment, a ±45° carbon fiber layer is enclosed by a 0°/90° glass fiber layer. The following structure may, therefore, result for the first surface course:
0°/90° glass fiber layer (approx. 0.16 mm);
0°/90° glass fiber layer (approx. 0.26 mm);
0°/90° glass fiber layer (approx. 0.26 mm).
±45° carbon fiber layer (approx. 0.32 mm);

According to the invention, the first cover layer can also be made of a uniform material, e.g. only glass fiber or only carbon fiber.

Preferably the glass fiber layers are S2 glass fiber layers.

The structure of the second cover layer can be as follows (from outside to inside, towards the core):
0°/90° glass fiber layer (approx. 0.16 mm);
±45° carbon fiber layer (approx. 0.32 mm).

According to the invention, the second cover layer can also be made of a uniform material, e.g. only glass fiber or only carbon fiber.

The above thickness specifications are particularly preferred if the core has a thickness of 5 to 12 mm, in particular 7 to 9 mm. This results in a total floor module thickness of less than 2 cm, in particular less than 1.5 cm. According to the invention, the thickness specifications can vary in the range of +/−50%, preferably in the range of +/−30%.

In one embodiment, the floor modules are equipped with significantly stronger cores. This may be necessary, for example, if holders for transport balls are provided in the floor modules. This leads to high point loads which can be absorbed by stronger floor modules. According to the invention, the core in this case has a thickness of 8 to 30 mm, in particular 10 to 20 mm. This can result in a total floor module thickness of less than 4 cm, in particular less than 2.5 cm. According to the invention, the thickness specifications can vary in the range of +/−50%, preferably in the range of +/−30%. Even in this embodiment, there may be coreless areas with a thickness of less than 8 mm, in particular less than 6 mm. The coreless area with a thickness of 3 to 5 mm is preferred. This can rest on cross members and/or profiles running in longitudinal direction, e.g. U-profiles for the accommodation of roller drive units and/or transoms.

In one embodiment, an S2 glass fiber layer is located on the outside of the floor module (both on the first cover layer and on the second cover layer). This improves fire safety and prevents rapid wear of the respective module (high impact resistance).

At least one of the floor modules may comprise a local layer elevation for forming the edge region and/or a support section and/or for forming one of the receptacles for a functional element, in particular the transport balls, and/or for forming a drainage trough.

The elevation of the layers leads to an increased stability in the respective area. In one embodiment, the edge regions comprise additional layers of carbon and/or aramid and/or glass fibers.

In addition, the number of layers can be increased at those points where recesses are provided, e.g. to accommodate functional elements. It is also conceivable to increase the number of layers in various areas above recesses where the core has been removed and to exert so much pressure at these points during production of the respective floor module that the first and second cover layers contact each other and form a material bond during curing. Due to the increased number of layers, corresponding areas can be used as fixing points or for other applications. Ultimately, it is possible to create functional areas in the respective floor modules during production, which can be used as lashing points, for drainage, etc.

This leads to a weight reduction and simplifies installation.

At least one edge of the floor module may have an upwardly curved and/or upwardly sloping section to cover the fuselage. At an edge only if the floor module is mounted in the area of the aircraft door. Otherwise, these curved sections may be provided on both sides of a floor module. This results in a further simplification in the manufacture and assembly of the overall arrangement. In addition, the section, which is curved compared to the flat surface of the cover element, leads to a stiffening of the overall arrangement. In general, however, two cores can also be arranged next to each other in this concrete design of the floor module. In the area between the cores, a coreless area is provided, e.g. for mounting on a longitudinal beam, at which the cover layers are connected to form a material bond.

The floor module preferably has connecting elements in some areas between the cover layers. This results in an increased stiffness of the overall arrangement. Such a connecting element can, for example, comprise pipe sleeves by means of which fastening means, in particular screws for fastening cargo handling systems, e.g. tie-down elements, can be connected directly to cross members of the cargo hold. In this case “killing two birds with one stone” applies: Fastening of the floor module, transfer of tractive forces into the aircraft structure.

As already explained, the floor module is preferably designed as a hybrid composite part, e.g. with carbon and/or glass fiber reinforcement. This means that the desired three-dimensional shape can be achieved in a heatable press mold, ensuring particularly efficient production of the floor module with high strength and low weight.

It follows from the above that a method for producing a described floor module or cargo deck is also claimed to be in accordance with the invention.

The object mentioned above is also solved by a floor module for a cargo deck, which includes:
at least one core in the form of a foam core and/or structural core which is embedded between a first upper cover layer of fiber-reinforced plastic and a second lower cover layer of fiber-reinforced plastic;
a coreless peripheral edge region for producing a materially bonded connection, in particular a flat connection, between the cover layers, wherein sections of the coreless peripheral edge region are formed in a flat manner for bearing on structural elements and defining a support plane;
a coreless drainage region, wherein at least sections of the coreless drainage region form a drainage trough in which the upper cover layer lies below the support plane.

The object mentioned above is also solved by a method for the production of a floor module for a cargo deck of an aircraft.

The method shall preferably include the following steps:
(a) cutting recesses from a core, wherein the core is a foam core and/or a structural core;
b) arranging the core between first fiber layers and second fiber layers, wherein the fiber layers comprise carbon and/or aramid and/or glass fibers in such a way that the fiber layers project beyond the core at the sides to form an edge region;
c) arranging frame parts in the recesses to produce inserts, preferably to accommodate transport balls;
d) curing, preferably under pressure and/or at a temperature of more than 60° C., an applied synthetic resin in such a way that the fiber layers and the frame parts are bonded to the core.

A core element of the manufacturing method according to the invention is that functional elements of the cargo deck are integrally formed in the floor modules. In the manufacturing method described, these are inserts for holding transport balls.

The curing temperature can be in a range of 60 to 200° C., preferably in a range of 130 to 150° C. Preferably a temperature of more than 100° C. is maintained for a period of 20 to 80 minutes, in particular 25 to 60 minutes. Curing can be carried out simultaneously under pressure, e.g. in a press. Preferably a pressure between 60 and 100 N/cm², e.g. 75 N/cm², is applied.

The inserts can be made from the materials already explained in connection with the device. It is important for the function that these inserts are bonded to the entire fiber-composite material. The synthetic resin required for the manufacture of the vehicle composite material leads to the necessary material bond during the manufacturing process. Preferably pre-impregnated fibers, so-called “prepregs”, are used, which have a resin content of more than 40% (mass content), in particular of more than 47%. The resin content can be in the range of approx. 47-50%. With this resin content, a good bond to the core or core layer and a high surface quality is achieved. The upper limit of approx. 50% resin content ensures an advantageous final weight and prevents the formation of sticky surfaces.

The method described may include cutting out recesses corresponding to the recesses in the core layers in at least some of the fiber layers. Cutting can be done either before the fiber layers are placed or when the insert is inserted.

The described steps b) to d) can be carried out in a press with a press table and a press ram or press punch. This is preferably a heated press so that the floor module is manufactured under pressure and heat, so that the fiber-composite material hardens quickly and in a defined manner. As an option, the heating can also be integrated into the mold.

The press, in particular the tool, may include positioning aids, with at least some of the frame parts arranged on or surrounding the positioning aid. The positioning aids are designed in such a way that they have a certain elasticity, which makes it possible to compensate for the dimensional changes between the tool and the composite material caused by temperature changes during the curing process. This avoids stresses that would otherwise arise between the composite component and the molding/positioning aid during the cooling process, which would lead to damage or at least to more difficult demolding, which is particularly important for components with several positioning aids. For example, the positioning aids can at least partially consist of an elastomer.

The positioning aids can be disc-shaped elements, which ensure efficient insertion of the frame parts into the fiber-composite material. It is conceivable to provide sharp edges on the positioning aids to ensure that fiber layers and/or the core are cut through.

Making at least one of the inserts may include inserting first frame parts from a first side of the core and inserting second frame parts from a second side such that a first frame part and a second frame part engage in each case into each other, preferably to form a latching connection.

In one embodiment, the first frame part is arranged in the mold, preferably by using the positioning aids. Then synthetic resin impregnated (prepreg) fiber layers are inserted. The core is placed on the fiber layers and further fiber layers are positioned above the core. Finally, the second frame parts can be inserted into the core from the other side, penetrating the upper fiber layers. The final fixing of the frame parts into each other can take place in the course of closing the press.

The method may include the insertion of additional fiber layers prior to step (d) in such a way that there is a local increase in the number of layers in partial areas of the floor module so as to produce support and/or attachment areas and/or local reinforcements. In one embodiment, corresponding additional fiber layers are provided in the edge region of the respective floor module, which is essentially coreless. The additional fiber layers can, for example, be two 0°/90° layers with a layer thickness of approx. 0.9 mm each.

In one embodiment, at least some sections are provided with recesses in the core, wherein pressure is exerted on the sections by means of an appropriately designed tool in such a way that the first and second fiber layers are bonded together. This results in the advantages that have already been explained in this context with regard to the device.

The edge regions can be at least partially cured in such a way that at least sections of the edge regions are inclined relative to a support plane of the floor module, in particular at an acute angle.

After the floor module has been manufactured, at least one housing with a transport ball can be snapped into at least one of the inserts. In addition or alternatively, sealing strips can be glued on in the form already explained. It is also possible to attach fixing points to the floor modules.

In one embodiment, the tools of the press are roughened by sandblasting in particular. Preferably, at least a roughening of the tool which produces the upper side of the floor module is carried out. Due to the rough surface of the tool, a rough structure is obtained at least on the upper side of the floor module, which allows safe walking on the floor module (“anti-slip function”). The floor module, therefore, has a non-slip finishing layer. The roughening can take place locally, i.e. on relevant, e.g. accessible, partial areas. Preferably, connection surfaces that are not accessible from above when installed are not produced with a roughened tool in order to keep the manufacturing process as efficient as possible.

The method may involve the formation of a drainage trough, for example using an appropriate tool. The structural design of the drainage trough can be carried out in one pressing step, in which heat for curing is preferably applied at the same time. The formation of the drainage trough may involve the insertion of additional fiber layers, as described above. In the pressing step, drainage channels can also be created which are suitable for draining liquid from the floor modules into the drainage trough.

The formation of the drainage trough may be followed by a step of providing an opening and/or an outlet, e.g. in the form of a discharge nozzle.

In the following, several embodiment examples of the invention are explained in more detail by reference to the illustrations, wherein:

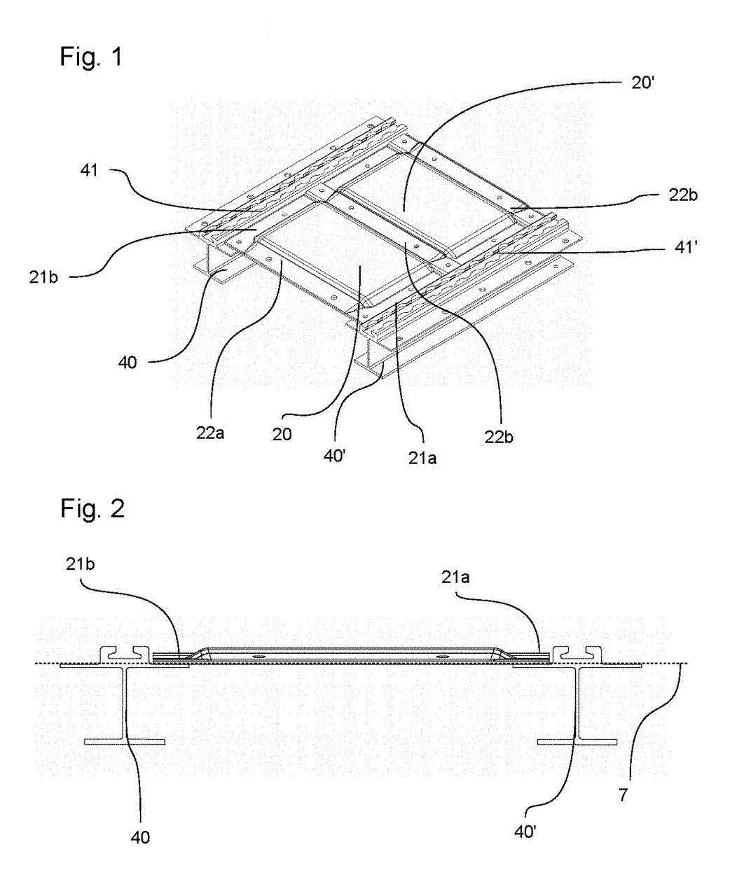

FIG. 1 shows a perspective view of two floor modules inserted between two longitudinal beams of an aircraft;

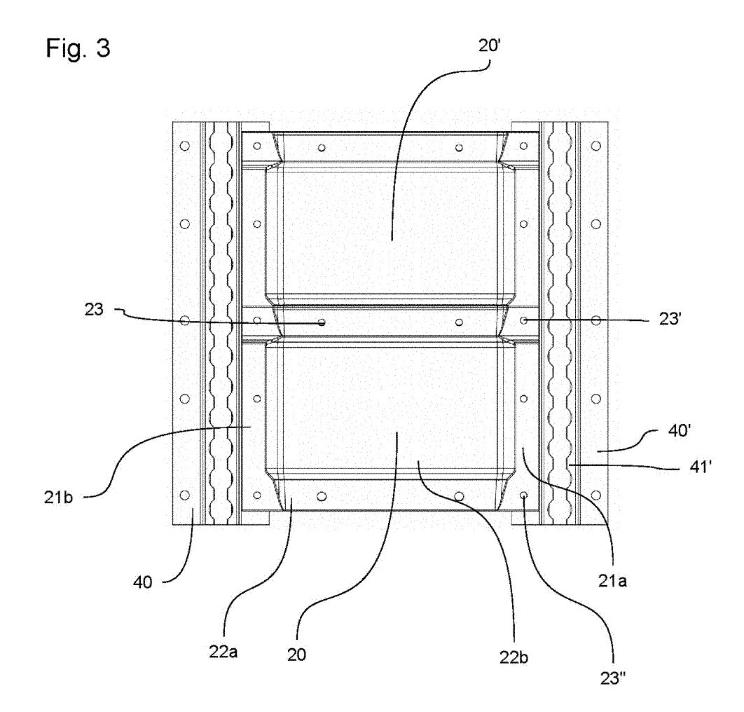

FIG. 2 shows a front view of the front floor module between the longitudinal members from FIG. 1;

FIG. 3 shows a top view of the floor modules from FIG. 1;

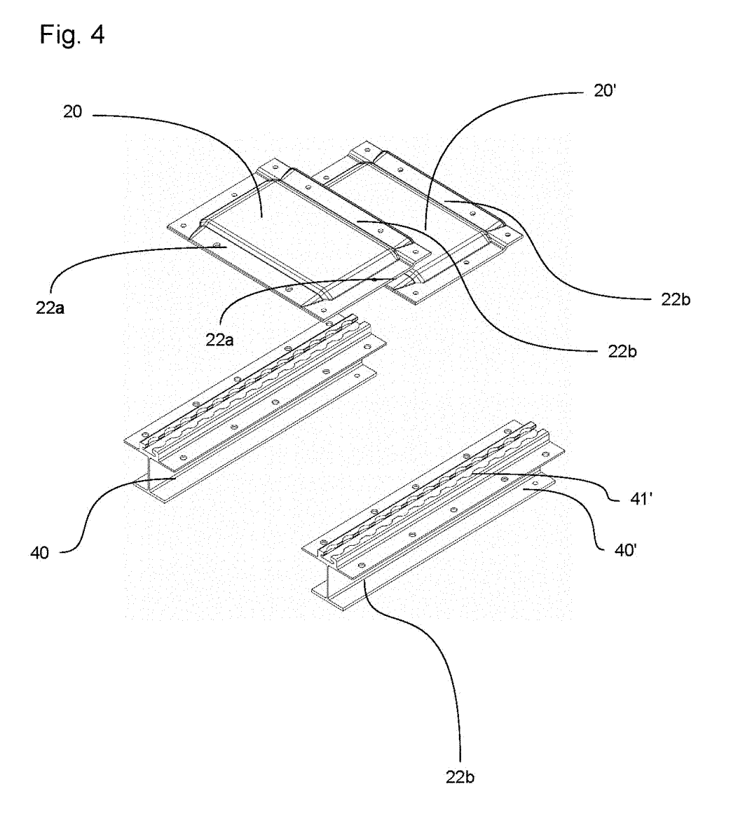

FIG. 4 shows a perspective view of the two floor modules and the two longitudinal beams from FIG. 1, wherein the floor modules are not arranged in the longitudinal beams;

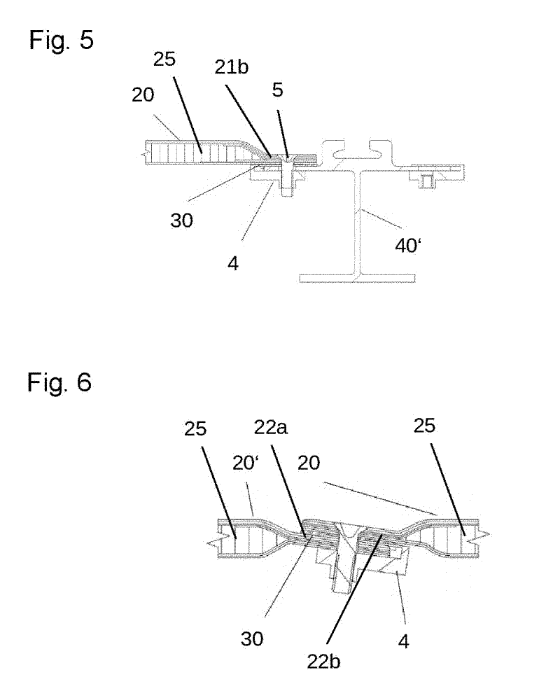

FIG. 5 shows a cross-section through one of the two longitudinal beams from FIG. 1;

FIG. 6 shows a cross-section through the area of the two floor modules from FIG. 1 in which they overlap;

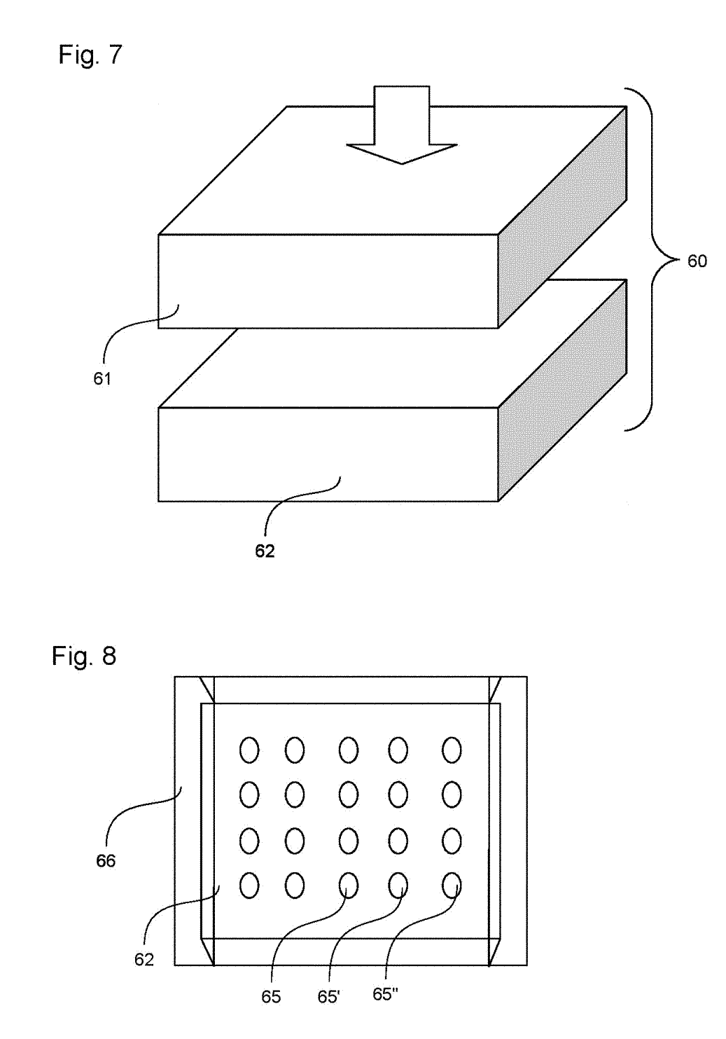

FIG. 7 shows a schematic representation of a press for the production of floor modules;

FIG. 8 shows a top view of the press table of the press from FIG. 7;

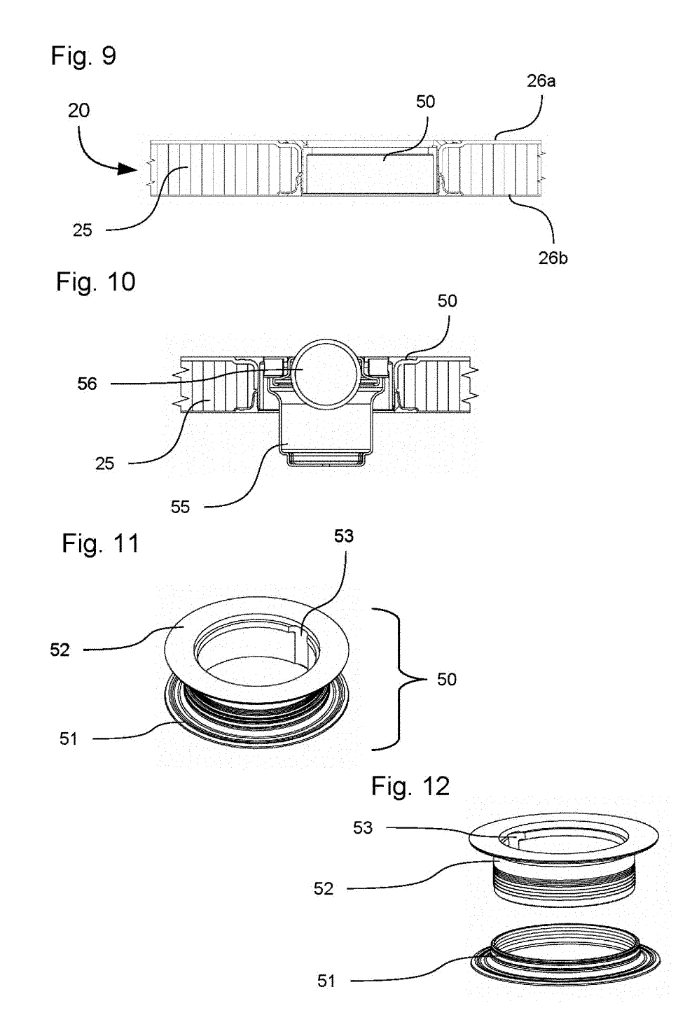

FIG. 9 shows a section through a floor module according to the invention with an insert;

FIG. 10 shows a section through the floor module from FIG. 9, wherein a housing with a transport ball is snapped into the insert;

FIG. 11 shows a detailed view of the insert from FIG. 9;

FIG. 12 shows the insert from FIG. 11 in an exploded view;

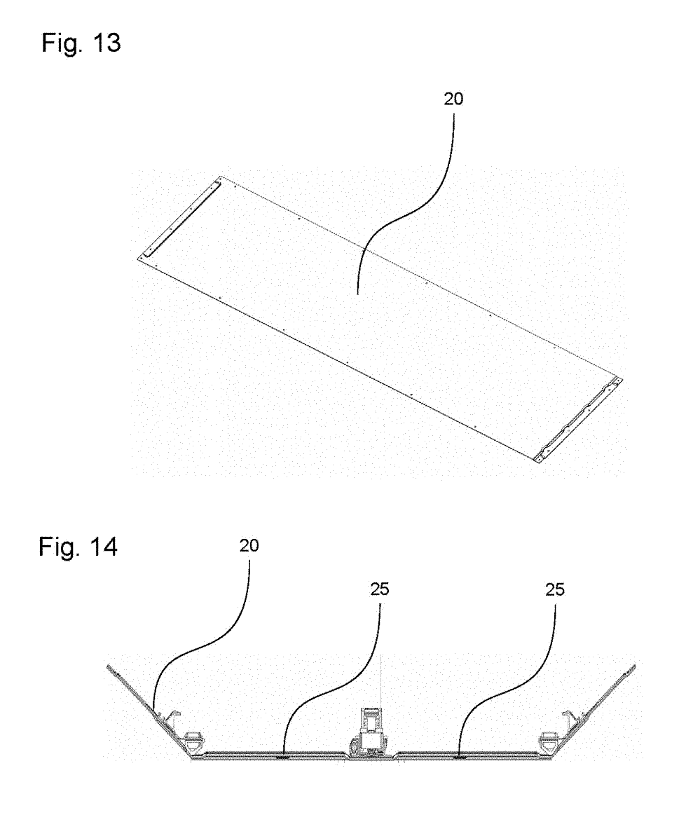

FIG. 13 shows a first variant of the floor module according to the invention;

FIG. 14 shows a second variant of the floor module according to the invention;

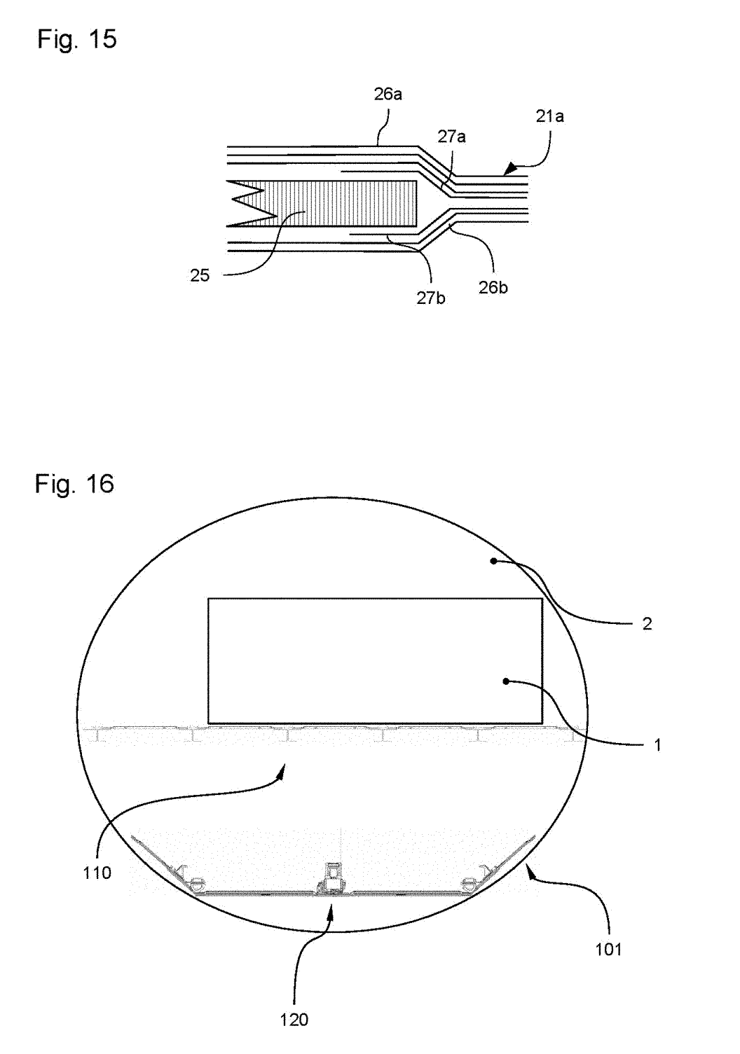

FIG. 15 shows a schematic section through the edge region of a floor module;

FIG. 16 shows a schematic section through the cargo hold of an aircraft;

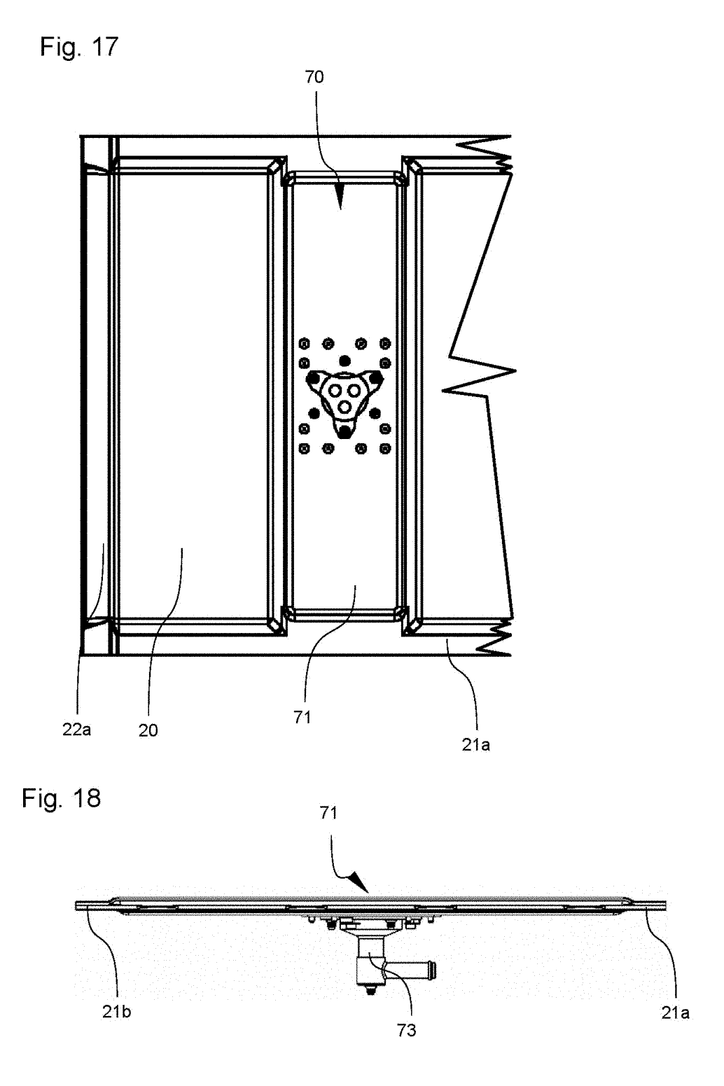

FIG. 17 shows a third variant of the floor module according to the invention with drainage trough;

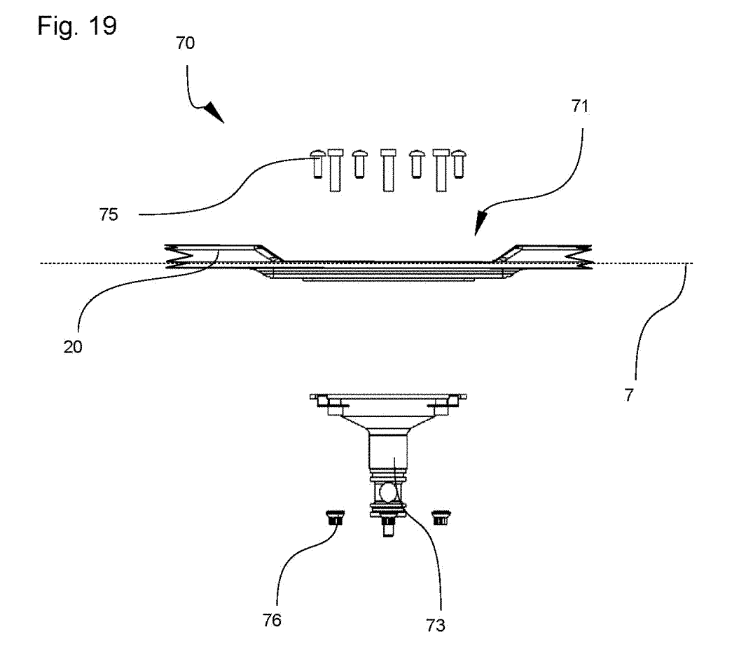

FIG. 18 shows a side view of the third variant according to FIG. 17;

FIG. 19 shows an exploded view of the drainage trough from FIG. 18.

In the following description, the same reference numbers are used for identical and equivalent parts.

FIG. 16 shows a schematic section through the fuselage of an aircraft. The section shows that cargo aircraft usually have two different cargo decks, an upper cargo deck 110 and a lower cargo deck 120. In FIG. 16, a container 1 is schematically arranged on the upper cargo deck 110 within cargo space 2. The outer skin 101 forms the boundary of cargo compartment 2.

Floor modules 20, 20′ according to the invention can be used as area modules for both the upper cargo deck 110 and the lower cargo deck 120.

FIG. 1 schematically shows how floor modules 20, 20′ can be installed in the upper cargo deck 110. The representations in FIGS. 1 to 6 are strongly schematized in order to explain the functional principle of the floor modules 20, 20′ according to the invention. The proportions of the individual elements do not necessarily coincide.

In FIG. 1, the two floor modules 20, 20′ rest on a first longitudinal beam 40 and a second longitudinal beam 40′. The longitudinal beams 40, 40′ essentially have the profile of a double-T beam. On the upper side of the two longitudinal members 40, 40′ a perforated rail 41 or 41′ is attached in the middle, which also extends in the longitudinal direction. The perforated rail can be an integral part of the respective longitudinal beam 40 or 40′. Alternatively, the perforated rail 41, 41′ is screwed onto the respective longitudinal beam 40, 40′. The floor modules, more precisely the left and right edge sections 21a, 21b of the two floor modules 20, 20′, lie between the elevations forming the perforated rails 41, 41′. The floor modules 20, 20′ are arranged in a row one behind the other. The front floor module 20 is thus in front of the rear floor module 20′. In summary, a closed and accessible cargo deck can thus be formed.

A front edge section 22a is located at the front side of the front floor module 20 and a rear edge section 22b is located at the rear side of the front floor module 20. Corresponding edge sections 22a, 22b are also provided on the rear floor module 20′. It can already be seen from FIG. 1 that the front and rear floor modules 20, 20′ overlap in the rear edge section 22a of the front floor module 20 and in the front edge section 22a of the rear floor module 20′ respectively.

The overlapping front and rear edge sections 22a, 22b of the two floor modules 20, 20′ are described in FIG. 4.

Both FIG. 1 and FIGS. 2 and 4 show that the front edge sections 22a of the two floor modules 20, 20′ have an upper side which is inclined downwards towards a support plane 7 of the floor modules 20, 20′. Correspondingly, the rear edge sections 22b of the floor modules 20, 20′ are inclined upwards, so that, as shown in FIG. 1, a precisely fitting connection can be established between the floor modules 20, 20′. The support plane can be defined by the edge sections 21a, 21b, which rest on the longitudinal beams 40, 40′.

FIG. 6 shows a section through this overlapping area, wherein a clip groove 4 is provided here at the front edge section 22a of the rear floor module 20′, into which a screw engages which connects the front and rear floor modules 20, 20′, in particular the respective front and rear edge sections 22a, 22b, to one another. Between these edge sections 22a, 22b there is a sealing strip 30, which seals the connection.

The floor modules 20, 20′ according to the invention are rectangular in the embodiment example described and have a large number of holes 23, 23′, 23″ which are provided both in the left and right edge sections 21a, 21b and in the front and rear edge sections 22a, 22b. According to the invention, however, floor modules 20, 20′ can also be manufactured with dimensions specially adapted to the requirements of the respective aircraft. For example, any essentially square or triangular surfaces can be produced, which are particularly advantageous for covering the cargo deck in the narrowing rear area.

The holes 23, 23′ in the left and right edge sections 21a, 21b allow the floor modules 20, 20′ to be screwed to the longitudinal members 40′ and 40 respectively. The holes 23 in the front and rear edge sections 22a, 22b allow the floor modules 20, 20′ to be screwed together as described above. In summary, this results in a continuous chain or series of floor modules spanning the entire upper cargo deck 120 in the longitudinal direction of the aircraft.

FIG. 5 shows a section through the longitudinal member 40′, wherein the floor module 20 is screwed to it via a screw 5. FIG. 5 also shows a sealing strip 30 which performs a sealing function between the floor module 20 and the longitudinal member 40′. In total, the cargo deck can be covered with the sealing strips 30, as shown in FIGS. 5 and 6, in such a way that it is watertight and, if necessary, gas-tight.

FIGS. 5, 6 and 15 show that the floor modules 20, 20′ are manufactured as fiber-composite materials. They each comprise a structural core 25 in the middle, for example a honeycomb core or foam, which is surrounded by fiber layers forming the cover layers 26a, 26b. Additional fiber layers are inserted in the edge regions, for example in the right edge section 21b shown in FIG. 5 or in the front and rear edge sections 22a, 22b shown in FIG. 6. These are designated in FIG. 15 as additional layers 27a, 27b. These additional layers result in the floor modules 20, 20′ having increased strength and rigidity in the edge regions, so that the edge regions can perform the support function already described (see also FIG. 5).

According to the invention, the floor modules 20, 20′ can also be equipped with integrated functional units, for example a transport ball 56 (see FIG. 10). FIGS. 9 to 12 explain this in more detail. The embodiment example according to FIGS. 1 to 4 does not have any corresponding functional units.

In the floor modules 20, 20′, in particular in the area where the flat structure core 25 is intended, recesses can be made in which inserts 50 are integrated (see FIG. 9).

The inserts can be used to hold a housing of a transport ball 56 (see FIG. 10). According to the invention, the inserts can also perform other functions.

In one embodiment example, the insert 50 has an undercut 53 (see FIGS. 10 and 11), into which a detent of the housing 55 engages, so that the transport ball 56 is securely held. As shown in FIG. 12, the insert 50 can be made in two parts, a lower frame part 51 and an upper frame part 52, which engage into each other.

A corresponding insert is particularly advantageous for the manufacturing method of the floor modules 20, 20′ according to the invention.

A corresponding production preferably takes place in a press 60, as shown, by way of example, in FIG. 7. The press 60 can, therefore, comprise a press table 62 and a press plunger 61, wherein the press plunger 61 can be applied with pressure against the press table 62. In order to manufacture the floor modules 20, 20′ according to the invention, the fiber layers forming the cover layers 26a, 26b and the structure core 25 are placed in the press 60, heated and pressed together.

In one embodiment example of the manufacturing method, the press table (or mold) 62 comprises, in addition to a frame 66 for producing the inclined front and rear edge sections 22a, 22b, positioning elements 65, 65′, 65″, which are distributed over the press table. To produce a floor module according to the invention, these positioning elements 65, 65′, 65″ are equipped with upper frame parts 52, as shown in FIG. 12. This is followed by fiber layers which preferably have recesses in the areas of the positioning elements 65, 65′, 65″. A structural core 25, also provided with corresponding recesses, is laid on the fiber layers, which later form the upper cover layer 26a. Further fiber layers are placed on the structure core 25 to produce the lower cover layer 26b. Finally, the lower frame parts 51 are inserted. After heating and warming up this layer structure, a fiber-composite material with inserts 50 is obtained, as shown, by way of example, in FIG. 9.

According to the invention, numerous variants are conceivable. As can be seen from FIG. 13, considerably larger floor modules 20 can be produced in this way. It is also possible, as shown in FIG. 14, to use a suitable press to produce a floor module with inclined wing sections. Corresponding floor modules 20 are particularly advantageous in the lower cargo deck area 120. The floor modules 20, 20′ according to the invention can be equipped with one or more structural cores 25. As can be seen from FIG. 16, coreless areas, e.g. with an increased number of layers, can be provided between the structural cores 25 for fastening the floor modules 20, 20′ to structural elements of the aircraft and/or for accommodating functional units, e.g. roller conveyors or PDUs.

FIG. 17 shows a further variant of a floor module 20 according to the invention, which, similar to the previously described floor modules 20, 20′, has front and rear inclined edge sections 22a, 22b. Left and right edge sections 21a, 21b are also provided. In total, the floor module 20 has a rectangular shape as shown in FIG. 17, resulting in an elongated walkable surface divided by a drainage trough 71. The drainage trough 71 is part of a drainage system 70 for draining liquids. In the top view shown in FIG. 17, the drainage trough 71 has an essentially rectangular dimension and extends almost over the entire width of the floor module 20, with the exception of the edge sections 21a and 21b.

There is an opening in the center of the drainage trough 71 on the underside of which there is a discharge nozzle 73 (see FIGS. 18 and 19). The discharge nozzle 73 is connected to a drainage system and ensures that the cargo deck does not allow gases or liquids to enter the bilge despite the drainage function. The drainage trough 71 drops down towards the opening so that efficient drainage can be ensured.

In one embodiment example, a sieve is provided to prevent clogging of the drainage system. In the embodiment example shown in FIG. 17-19, the discharge nozzle 73 is attached to the drainage trough 71 of the floor module 20 by means of drainage screws 75 and drainage nuts 76. Theoretically, further stiffening surface elements may be provided on the top side of the floor module 20 to ensure secure attachment of the discharge nozzle 73.

The drainage trough 71 can be designed as part of the manufacturing method in accordance with the invention in such a way that it extends into an area below the support level 7. The deepest point of the drainage trough 71 can be at least 1.5 or 2.5 cm away from this support plane 7. In one embodiment example, the drainage trough 71 is manufactured in a coreless area, with an increased number of fiber layers, e.g. carbon fiber layers, being provided depending on the application. The structure of the drainage trough 71 can be created by pressing the floor module 20 with a suitable tool. In this pressing step, the fiber-composite material can be cured simultaneously.

### LIST OF REFERENCE NUMERALS

1 Container

2 Cargo space

4 Clip groove

5 Screw

7 Support plane

20, 20′ Floor module

21a, 21b Left and right edge section

22a, 22b Front and rear edge section

23, 23′, 23″ Holes

25 Structure core

26a, 26b Cover layer

27a, 27b Additional layers

30 Sealing strip

40, 40′ Longitudinal member

41, 41′ Perforated rail

50 Insert

51 Lower frame part

52 Upper frame part

53 Undercut

55 Housing

56 Transport ball

57 Detent

60 Press

61 Press plunger

62 Press table

65, 65′, 65″ Positioning elements

66 Press frame

70 Drainage system

71 Drainage trough

73 Discharge nozzle

75 Drainage screws

76 Drainage nuts

101 Outer skin of aircraft

110 Upper cargo deck

120 lower cargo deck

1. A cargo deck of an aircraft, comprising a series of at least two floor modules arranged side by side and made of a fiber-composite material, wherein the floor modules each comprise at least one core in the form of a foam core and/or structural core which is interposed between a first cover layer made of fiber-reinforced plastic and a second cover layer made of fiber-reinforced plastic, wherein the floor modules each comprise a coreless peripheral edge region for producing an, in particular laminar, materially bonded connection between the cover layers, wherein the floor modules are arranged in such a way that sections of the coreless edge regions of the floor modules arranged side by side overlap one another, wherein at least one sealing strip, in particular made of silicone foam, is provided between the mutually overlapping edge regions.

2. The cargo deck according to claim 1, wherein the core of at least one floor module comprises recesses, in particular circular ones, having a diameter of at least 2 cm, into which inserts for receiving transport balls are introduced.

3. The cargo deck according to claim 1, wherein at least one of the transport balls is rotatably mounted in a housing which is latched into the insert.

4. The cargo deck according to claiml, wherein the overlapping sections of the edge regions comprise a lower edge section of a first floor module and an upper edge section of a second floor module, wherein the lower edge section comprises a downwardly inclined top surface and the upper edge section comprises an upwardly inclined bottom surface.

5. The cargo deck according to claim 1, wherein the overlapping sections of the edge regions are at least partially screwed together, preferably using a clip groove.

6. The cargo deck according to claiml, wherein the first cover layer and/or the second cover layer comprises a plurality of carbon and/or aramid and/or glass fiber layers.

7. The cargo deck according to claim 6, wherein at least one floor module comprises a local layer elevation for forming the edge region and/or a support section and/or for forming a/the receptacle of a/the transport ball and/or for forming a drainage trough.

8. A floor module for a cargo deck according to claim 1, comprising:
at least one core in the form of a foam core and/or structural core which is interposed between a first upper cover layer of fiber-reinforced plastic and a second lower cover layer of fiber-reinforced plastic;
a coreless peripheral edge region for producing a materially bonded connection, in particular a laminar one, between the cover layers, wherein sections of the coreless peripheral edge region are designed to rest laminar on structural elements and define a support plane;
a coreless drainage region, wherein at least sections of the coreless drainage region form a drainage trough in which the upper cover layer lies below the support plane.

9. A method for manufacturing a floor module for a cargo deck of an aircraft, comprising the steps of:
a) cutting out recesses from a core, wherein the core is a foam core and/or a structural core;
b) arranging the core between first fiber layers and second fiber layers, wherein the fiber layers comprise carbon and/or aramid and/or glass fibers such that the fiber layers protrude beyond the core at the sides to form an edge region;
c) arranging frame parts in the recesses for producing inserts, preferably for receiving transport balls;
d) curing, preferably under pressure, an applied synthetic resin in such a way that the fiber layers and the frame parts are bonded to the core.

10. The method for manufacturing a floor module according to claim 9, including cutting out recesses corresponding to the recesses in the core layer in at least some of the fiber layers.

11. The method for manufacturing a floor module according to claim 9, wherein at least the steps b) to d) are carried out in a press having a press table and a press ram.

12. The method for manufacturing a floor module according to claim 11, wherein the press, in particular the press table, comprises positioning aids, wherein at least some of the frame parts are arranged on the positioning aids or surrounding them.

13. The method for manufacturing a floor module according to claim 9, wherein the production of the inserts comprises an insertion of first frame parts on a first side of the core and an insertion of second frame parts on a second side of the core, wherein a first frame part and a second frame part in each case engage one another, preferably by producing a latching connection.

14. The method for manufacturing a floor module according to claim 9, including inserting additional fiber layers before step d) such that a local increase in the number of layers is present in partial regions of the floor module in order to produce support and/or fastening regions and/or at least one drainage trough.

15. The method for manufacturing a floor module according to claim 14, wherein recesses are provided in the core in at least some partial regions, wherein pressure is exerted on the partial regions by means of an appropriately designed tool in such a way that the first and second fiber layers are bonded to one another.

16. The method for manufacturing a floor module according to claim 9, wherein the edge regions are at least partially cured in such a way that at least sections of the edge region are inclined relative to a support plane of the floor module, in particular at an acute angle.

17. The method for manufacturing a floor module according to claim 9, characterized by:
an insertion, in particular latching, of at least one housing with a transport ball into at least one of the inserts; and/or
gluing at least one sealing strip to at least one section of the edge region; and/or
screwing a fixing point into one of the fiber-reinforced partial regions.
